(19) United States
(12) Patent Application Publication
(10) Pub. No.: US 2008/0034333 A1
(43) Pub. Date: Feb. 7, 2008

(54) SYSTEM AND METHOD FOR CONVERTING A MEASURING PROGRAM

(75) Inventors: CHIH-KUANG CHANG, Tu-Cheng (TW); MIN WANG, Shenzhen (CN); XIN-YUAN WU, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/749,169

(22) Filed: May 16, 2007

(30) Foreign Application Priority Data
Aug. 2, 2006 (CN) 200610061948.3

(51) Int. Cl. G06F 17/50

(52) U.S. Cl. 716/3

(57) ABSTRACT

A computer based method for converting a measuring program is provided. The method includes the steps of: reading a measuring program to be converted from a measuring program storage area; converting a measure element sub-program having an initial format into a converted measure element sub-program having a designated format; converting a create element sub-program having an initial format into a converted create element sub-module having a designated format; converting a configure coordinates sub-program having an initial format into a converted configure coordinates sub-program having a designated format; converting an output dimension sub-program having an initial format into a converted output dimension sub-program having a designated format; transmitting and storing the converted sub-programs to the converted program storage area. A related system is also provided.

### BACKGROUND OF THE INVENTION

1. Field of the Invention

The present invention generally relates to systems and methods of data conversion, and more particularly to a system and method for converting a measuring program.

2. Description of related art

With the improvement of measuring equipment precision, measuring equipment becomes more complex in configuration and more difficult in operation.

To date, there are various measuring equipments that have a high precision and a high speed in measuring physical dimensions and geometric tolerances of a product. Normally, for the purpose of measuring physical dimensions and geometric tolerances of a product with a high precision and a high speed, the measuring equipments are programmed for corresponding measuring programs with different formats. In order to measure a same product by utilizing the measuring equipments, a user must program the measuring equipments respectively. In this way, it is inconvenient and time consuming for the user to reprogram the measuring equipments and is impossible.

What is needed, therefore, is a system and a method for converting a measuring program, which can convert the measuring program into a converted measuring program quickly.

### SUMMARY OF THE INVENTION

A system for converting a measuring program includes a measuring program storage area for storing the measuring program to be converted, a conversion module for converting the measuring program into a converted measuring program, and a converted program storage area for storing the converted measuring program. The conversion module includes: a reading sub-module for reading the measuring sub-program to be converted from the measuring program storage area; a measure element converting sub-module for converting a measure element sub-program having an initial format into a converted measure element sub-program having a designated format; a create element converting sub-module for converting a create element program having an initial format into a converted create element sub-program having a designated format; a configure coordinates converting sub-module for converting a configure coordinates sub-program having an initial format into a converted configure coordinates sub-program having a designated format; an output dimensions converting sub-module for converting an output dimensions sub-program having an initial format into a converted output dimensions sub-program having a designated format; a saving sub-module for transmitting and storing the converted sub-programs to the converted program storage area.

A computer based method for converting a measuring program includes the steps of: reading a measuring program to be converted from a measuring program storage area; converting a measure element sub-program having an initial format into a converted measure element sub-program having a designated format; converting a create element sub-program having an initial format into a converted create element sub-module having a designated format; converting a configure coordinates sub-program having an initial format into a converted configure coordinates sub-program having a designated format; converting an output dimension sub-program having an initial format into a converted output dimension sub-program having a designated format; transmitting and storing the converted sub-programs to the converted program storage area.

Other systems, methods, features, and advantages of the present invention will be or become apparent to one with skill in the art on examination of the following drawings and detailed description.

### BRIEF DESCRIPTION OF THE DRAWINGS

FIG. 1 is a schematic diagram of hardware configuration of a system for converting a measuring program in accordance with one preferred embodiment;

FIG. 2 is a schematic diagram of function modules of an conversion module in FIG. 1;

FIG. 3 is a flowchart of a method for converting a measuring program in accordance with one preferred embodiment;

FIG. 4 is a flowchart of a method for converting a measure element sub-program in FIG. 3;

FIG. 5 is a flowchart of a method for converting a create element sub-program in FIG. 3;

FIG. 6 is a flowchart of a method for converting a configure light sub-program in FIG. 3;

FIG. 7 is a flowchart of a method for converting a configure coordinates sub-program in FIG. 3; and

FIG. 8 is a flowchart of a method for converting an output dimension sub-program in FIG. 3.

### DETAILED DESCRIPTION OF THE INVENTION

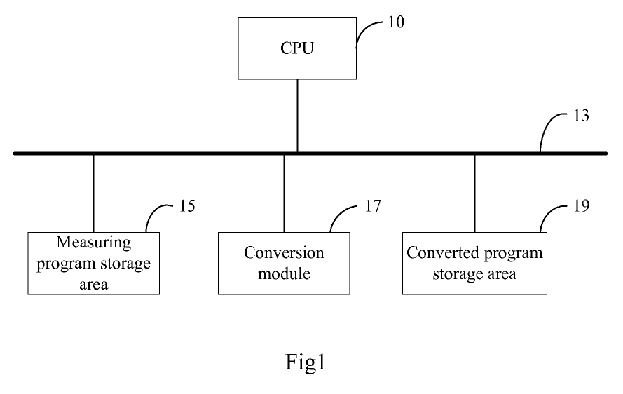

FIG. 1 is a schematic diagram of a hardware configuration of a system for converting a measuring program (hereinafter, “the system”), in accordance with a preferred embodiment. The system typically includes a Central Processing Unit (CPU) 10, a measuring program storage area 15, a conversion module 17, and a converted program storage area 19 each in communication with each other via a Universal Serial Bus (USB) 13.

The CPU 10 is configured for processing data transmitted between the measuring program storage area 15, the conversion module 17, and the converted program storage area 19 via the USB 13.

The measuring program storage area 15 is configured for storing measuring programs to be converted.

The conversion module 17 is configured for converting the measuring programs stored in the measuring program storage area 15 into converted measuring programs according to corresponding format-converting rules. Each of the format-converting rules correspond to corresponding measuring equipments programmed the converted measuring program. Different measuring equipments programmed for corresponding measuring programs with different formats to measuring a production.

The converted program storage area 19 is configured for storing the converted programs of the measuring programs.

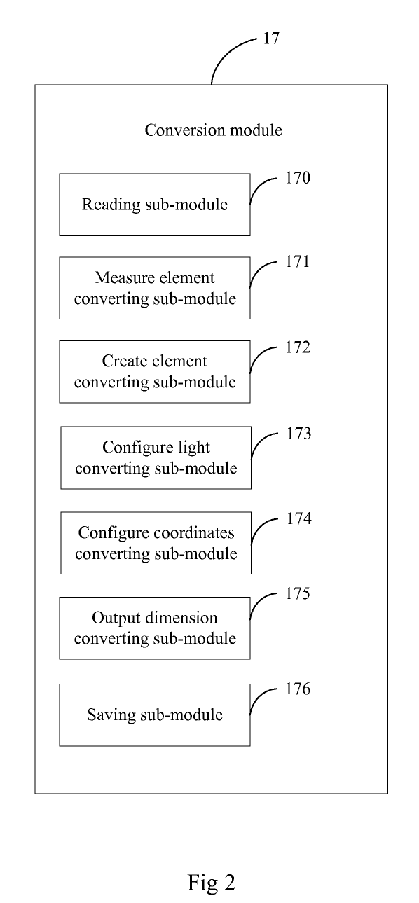

FIG. 2 is a schematic diagram of function modules of the conversion module 17. The conversion module 17 typically includes a reading sub-module 170, a measure element converting sub-module 171, a create element converting sub-module 172, a configure light converting sub-module 173, a configure coordinates converting sub-module 174, an output dimension converting sub-module 175 and a saving sub-module 176.

The reading sub-module 170 is configured for reading a measuring program to be converted from the measuring program storage area 15. The measuring program may include a measure element sub-program, a create element sub-program, a configure light sub-program, a configure coordinates sub-program, and an output dimension sub-program.

The measure element converting sub-module 171 is configured for converting the measure element sub-program having an initial format into a converted measure element sub-program having a designated format according to a corresponding format-converting rule. The measure element sub-program may include a measure point component, a measure line component, a measure plane component, and a measure circle component. Correspondingly, the converted measure element sub-program may include a converted measure point component, a converted measure line component, a converted measure plane component, and a converted measure circle component.

The create element converting sub-module 172 is configured for converting the create element sub-program having an initial format into a converted create element sub-program having a designated format according to the corresponding format-converting rule. The create element sub-program may include a create point component, a create line component, a create plane component, and a create circle component. Correspondingly, the converted create element sub-program may include a converted create point component, a converted create line component, a converted create plane component, and a converted create circle component.

The configure light converting sub-module 173 is configured for converting the configure light sub-program having an initial format into a converted configure light sub-program having a designated format according to the corresponding format-converting rules. The convert configure light sub-program sub-module 173 calculates a light value to be compensated between the configure light sub-program and the converted configure light sub-program, and converts the configure light sub-program into the converted configure light sub-program according to the light value.

The configure coordinates converting sub-module 174 is configured for converting the configure coordinates sub-program having an initial format into a converted configure coordinates sub-program having a designated format according to the corresponding format-converting rule. The configure coordinates sub-program may include an align plane component, a rotate coordinates component, an offset coordinates component, an align origin component, and a recall part coordinates system module. Correspondingly, the converted configure coordinates sub-program may include a converted align plane component, a converted rotate coordinates component, a converted offset coordinates component, a converted align origin component, and a converted recall part coordinates system component.

The output dimension converting sub-module 175 is configured for converting the output dimension sub-program having an initial format into a converted output dimension sub-program having a designated format according to the corresponding format-converting rule. The output dimension sub-program may include an output feature component, an output distance component, an output straightness component, an output circularity component, an output parallelism component, an output position component, an output perpendicularity component and an output text component. Correspondingly, the converted output dimension sub-program may include a converted output feature component, a converted output distance component, a converted output straightness component, a converted output circularity component, a converted output parallelism component, a converted output position component, a converted output perpendicularity component and a converted output text component.

The saving sub-module 176 is configured for transmitting and storing the converted sub-programs to the converted program storage area 19.

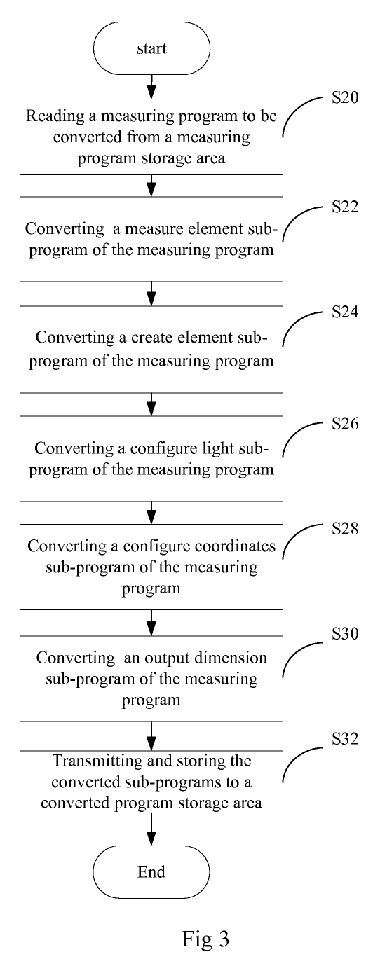

FIG. 3 is a flowchart of a method for converting a measuring program in accordance with one preferred embodiment.

In step S20, the reading sub-module 170 reads the measuring program to be converted from the measuring program storage area 15. The measuring program may include the measure element sub-program, the create element sub-program, the configure light sub-program, the configure coordinates sub-program, and the output dimension sub-program.

In step S22, the measure element converting sub-module 171 converts the measure element sub-program having an initial format into the converted measure element sub-program having a designated format according to the corresponding format-converting rule.

In step S24, the create element converting sub-module 172 converts the create element sub-program having an initial format into the converted create element sub-program having a designated format according to the corresponding format-converting rule.

In step S26, the configure light converting sub-module 173 converts the configure light sub-program having an initial format into the converted configure light sub-program having a designated format according to the corresponding format-converting rule.

In step S28, the configure coordinates converting sub-module 174 converts the configure coordinates sub-program having an initial format to the converted configure coordinates sub-program having a designated format according to the corresponding format-converting rule.

In step S30, the output dimension converting sub-module 175 converts the output dimension sub-program having an initial format to the converted output dimension sub-program having a designated format according to the corresponding format-converting rule.

In step S32, the saving sub-module 176 transmits and stored the converted components to the converted program storage area 19.

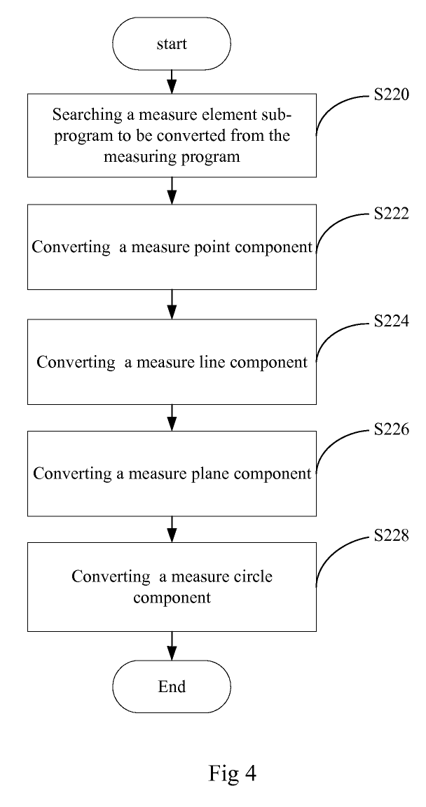

FIG. 4 is a flowchart of a method for converting the measure element sub-program in FIG. 3.

In step S220, the measure element converting sub-module 171 searches the measure element sub-program to be converted from the measuring program storage area 15. The measure element sub-program may include the measure point measuring component, the measure line component, the measure plane component, and the measure circle component.

In step S222, the measure element converting sub-module 171 converts the measure point component having an initial format into the converted measure point component having a designated format according to the corresponding format-converting rule.

In step S224, the measure element converting sub-module 171 converts the measure line component having an initial format into the converted measure line component having a designated format according to corresponding format-converting rule.

In step S226, the measure element converting sub-module 171 converts the measure plane component having an initial format into the converted measure plane component having a designated format according to the corresponding format-converting rule.

In step S228, the measure element converting sub-module 171 converts the measure circle component having an initial format into the converted measure circle component having a designated format according to the corresponding format-converting rule.

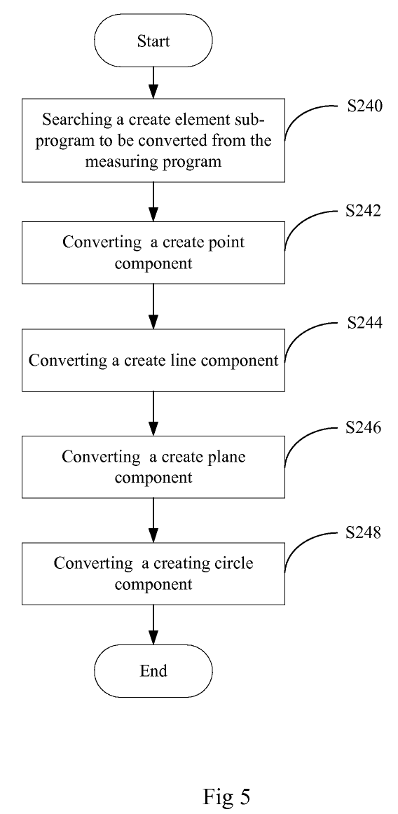

FIG. 5 is a flowchart of a method for converting the create element sub-program in FIG. 3.

In step S240, the create element converting sub-module 172 searches the create element sub-program to be converted from the measuring program storage area 15. The create element sub-program may include the create point component, the create line component, the create plane component, and the create circle component.

In step S242, the create element converting sub-module 172 converts the create point component having an initial format into the converted create point component having a designated format according to the corresponding format-converting rule.

In step S244, the create element converting sub-module 172 converts the create line component having an initial format into the converted create line component having a designated format according to the corresponding format-converting rule.

In step S246, the create element converting sub-module 172 converts the create plane component having an initial format into the converted create plane component having a designated format according to the corresponding format-converting rule.

In step S248, the create element converting sub-module 172 converts the create circle component having an initial format into the converted create circle component having a designated format according to the corresponding format-converting rule.

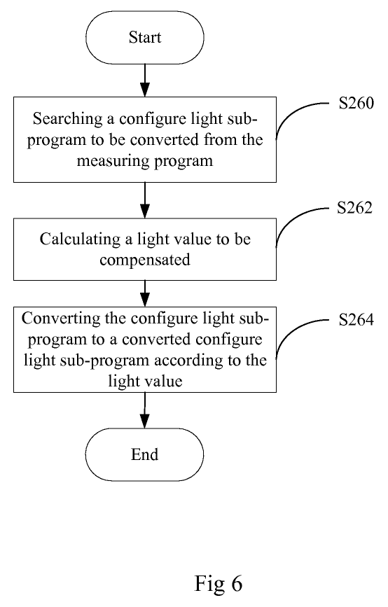

FIG. 6 is a flowchart of a method for converting the configure light sub-program in FIG. 3.

In step S260, the configure light converting sub-module 173 searches the configure light sub-program to be converted from the measuring program storage area 15.

In step S262, the configure light converting sub-module 173 calculates the light value to be compensated between the configure light sub-program and the converted configure light sub-program.

In step S264, the configure light converting sub-module 173 converts the configure light sub-program to the converted configure light sub-program according to the light value.

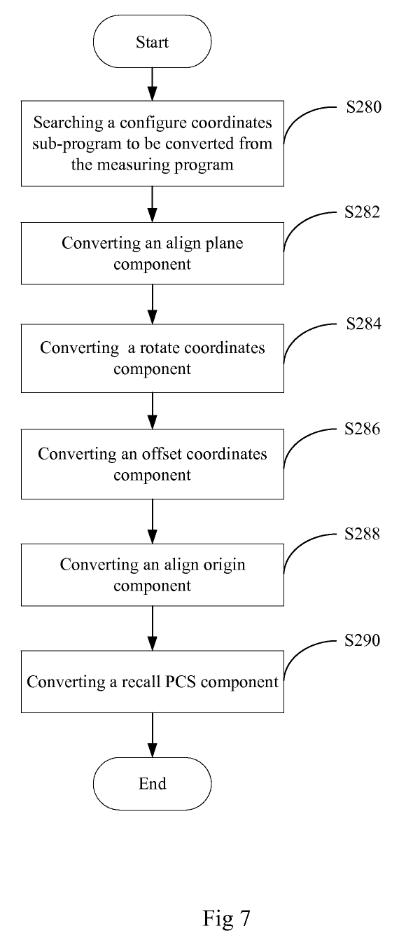

FIG. 7 is a flowchart of a method for converting the configure coordinates sub-program in FIG. 3.

In step S280, the configure coordinates converting sub-module 174 searches the configure coordinates sub-program to be converted from the measuring program storage area 15. The configure coordinates sub-program may include the align plane component, the rotate coordinates component, the offset coordinates component, the align origin component, and the recall part coordinates system component.

In step S282, the configure coordinates converting sub-module 174 converts the align plane component having an initial format into the converted align plane component having a designated format according to the corresponding format-converting rule.

In step S284, the configure coordinates converting sub-module 174 converts the rotate coordinates component having an initial format into the converted rotate coordinates component having a designated format according to the corresponding format-converting rule.

In step S286, the configure coordinates converting sub-module 174 converts the offset coordinates component having an initial format into the converted offset coordinates component having a designated format according to the corresponding format-converting rule.

In step S288, the configure coordinates converting sub-module 174 converts the align origin component having an initial format into the converted align origin component having a designated format according to the corresponding format-converting rule.

In step S290, the configure coordinates converting sub-module 174 converts the recall part coordinates system component having an initial format into the converted recall part coordinates system component having a designated format according to the corresponding format-converting rule.

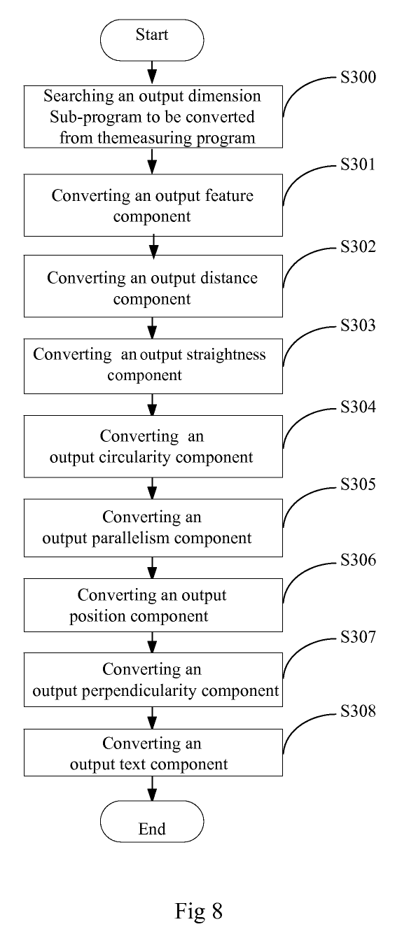

FIG. 8 is a flowchart of a method for converting the output dimension sub-program in FIG. 3.

In step S300, the output dimension converting sub-module 175 searches the output dimension sub-program from the measuring program storage area 15. The output dimension sub-program may include the output feature component, the output distance component, the output straightness component, the output circularity component, the output parallelism component, the output position component, the output perpendicularity component, and the output text component.

In step S301, the output dimension converting sub-module 175 converts the output feature component having an initial format into the converted output feature component having a designated format according to the corresponding format-converting rule.

In step S302, the output dimension converting sub-module 175 converts the output distance component having an initial format into the converted output distance component having a designated format according to the corresponding format-converting rule.

In step S303, the output dimension converting sub-module 175 converts the output straightness component having an initial format into the converted output straightness component having a designated format according to the corresponding format-converting rule.

In step S304, the output dimension converting sub-module 175 converts the output circularity component having an initial format into the converted output circularity component having a designated format according to the corresponding format-converting rule.

In step S305, the output dimension converting sub-module 175 converts the output parallelism component having an initial format into the converted output parallelism component having a designated format according to the corresponding format-converting rule.

In step S306, the output dimension converting sub-module 175 converts the output position component having an initial format into the converted output position component having a designated format according to the corresponding format-converting rule.

In step S307, the output dimension converting sub-module 175 converts the output perpendicularity component having an initial format into the converted output perpendicularity component having a designated format according to the corresponding format-converting rule.

In step S308, the output dimension converting sub-module 175 converts the output text component having an initial format into the converted output text component having a designated format according to the corresponding format-converting rule.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for converting a measuring program comprising a measuring program storage area for storing the measuring program to be converted, a conversion module for converting the measuring program into a converted measuring program, and a converted program storage area for storing the converted measuring program, the conversion module comprising:
a reading sub-module for reading the measuring program to be converted from the measuring program storage area;
a measure element converting sub-module for converting a measure element sub-program having an initial format into a converted measure element sub-program having a designated format;
a create element converting sub-module for converting a create element sub-program having an initial format into a converted create element sub-program having a designated format;
a configure coordinates converting sub-module for converting a configure coordinates sub-program having an initial format into a converted configure coordinates sub-program having a designated format;
an output dimensions converting sub-module for converting an output dimensions sub-program having an initial format into a converted output dimensions sub-program having a designated format; and
a saving sub-module for transmitting and storing the converted sub-programs to the converted program storage area.

2. The system according to claim 1, wherein the conversion module further comprises:
a configure light converting sub-module for converting a configure light sub-program having an initial format into a converted configure light sub-program having a designated format.

3. The system according to claim 1, wherein the measure element sub-program comprises a measure point component, a measure line component, a measure plane component and a measure circle component.

4. The system according to claim 1, wherein the create element sub-program comprises a create point component, a create line component, a create plane component and a create circle component.

5. The system according to claim 1, wherein the configure coordinates sub-program includes an align plane component, a rotate coordinates component, an offset coordinates component, an align origin component, and a recall part coordinates system component.

6. The system according to claim 1, wherein the dimension output sub-program includes an output feature component, an output distance component, an output straightness component, an output circularity component, an output parallelism component, an output perpendicularity component, an output position component, and an output text component.

7. A computer based method for converting a measuring program, the method comprising the steps of:
reading a measuring program to be converted from a measuring program storage area;
converting a measure element sub-program having an initial format into a converted measure element sub-program having a designated format;
converting a create element sub-program having an initial format into a converted create element sub-module having a designated format;
converting a configure coordinates sub-program having an initial format into a converted configure coordinates sub-program having a designated format;
converting an output dimension sub-program having an initial format into a converted output dimension sub-program having a designated format; and
transmitting and storing the converted sub-programs to the converted program storage area.

8. The method according to claim 7, further comprising:
converting a configure light sub-program having an initial format into a converted configure light sub-program having a designated format.
